(19) United States
(12) Patent Application Publication
(10) Pub. No.: US 2007/0080514 A1
(43) Pub. Date: Apr. 12, 2007

(54) Pneumatic suspension unit for a vehicle

(76) Inventors: Axel Stender, Coppenbrugge (DE); Rainer Risse, Pattensen (DE); Johann Lucas, Sehnde (DE); Norbert Witte, Lauenau (DE)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 10/579,373

(22) PCT Filed: Oct. 9, 2004
(86) PCT No.: PCT/EP04/11321

§ 371 Date: May 12, 2006

(30) Foreign Application Priority Data
Nov. 19, 2003 (DE) 103 54 057.1
Jul. 22, 2004 (DE) 10 2004 035 691.2

(51) Int. Cl. B60G 11/27

(52) U.S. Cl. 280/124.157

(57) ABSTRACT

The invention relates to a pneumatic suspension unit for a vehicle, comprising pneumatic suspension bellows (3) and an electronically controlled level control unit (1), which aerates and bleeds the pneumatic suspension bellows (3) as required by means of an electrically operated valve device (6, 7, 32, 33, 44, 45). The invention provides a pneumatic suspension unit for a vehicle, which is equipped with an electronic controller for the level control and in which the level of the vehicle body can nevertheless be modified during an interruption or malfunction of the power supply. To achieve this, the inventive system comprises at least one manual actuating element (18, 19), which when manually actuated permits the aeration and/or bleeding of the pneumatic suspension bellows (3), even during a malfunction of the power supply to the electronically controlled level control unit (1).

The invention relates to an air-suspension device according to the preamble of claim 1, for a vehicle.

An air-suspension device of the class in question is known from European Patent 0779167 B1.

Such an air-suspension device contains an electronically controlled level-regulating device. Compared with conventional air-suspension valves that are operated purely pneumatically, electronic control of the level-regulating device has the advantage, for example, of more comfortable regulation and greater functional diversity. Because of the electronic control, however, an air-suspension system of the class in question needs a power supply in order to execute its intended functions, such as raising or lowering the vehicle body in response to manual actuation of operating elements, for example in order to reach the level of a loading dock. Such a power supply is not always available in a vehicle that has been parked for the purpose of loading or unloading. Especially in the case of trailer vehicles that have been parked separately, or in other words without the tractor vehicle, supply of power to the electronic level-regulating device is not directly possible, due to the lack of an on-board battery.

The object of the invention is therefore to provide an air-suspension device for a vehicle, wherein electronic control is indeed provided for level regulation, but the level of the vehicle body can be changed even if the power supply has been turned off or is non-existent.

This object is achieved by the invention specified in claim 1. Improvements and advantageous configurations of the invention are specified in the dependent claims.

The invention has the advantage that, in return for relatively little additional complexity compared with known air-suspension devices containing an electronically controlled level-regulating device, it permits a reliable capability for selective manual change of the relative level of the vehicle body. For example, admission of air to and/or venting of the air-suspension bellows of the air-suspension device is possible even in the absence of power supply to the electronically controlled level-regulating device. A further advantage, especially for trailer vehicles, is that there is no need to provide an on-board battery or to supply a parked trailer vehicle externally with power by some other means.

The invention will be explained in more detail hereinafter and further advantages will be pointed out on the basis of practical examples, using drawings, wherein

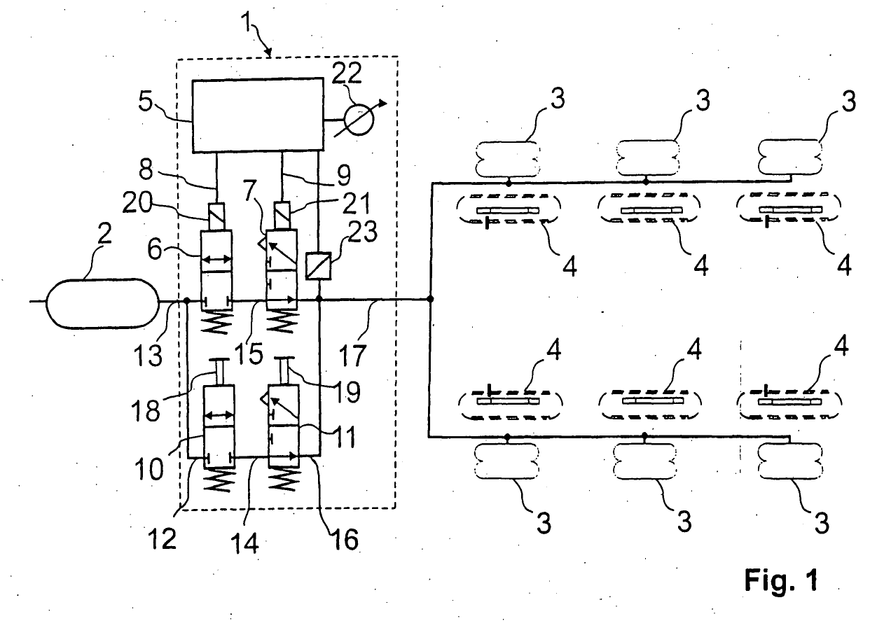

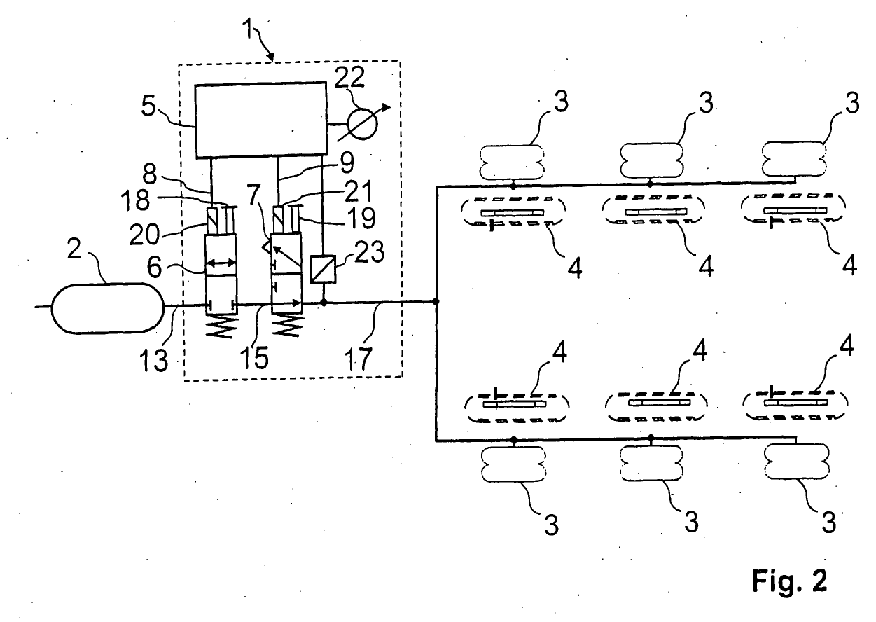

FIGS. 1 and 2 show practical examples of an air-suspension device for a vehicle, and

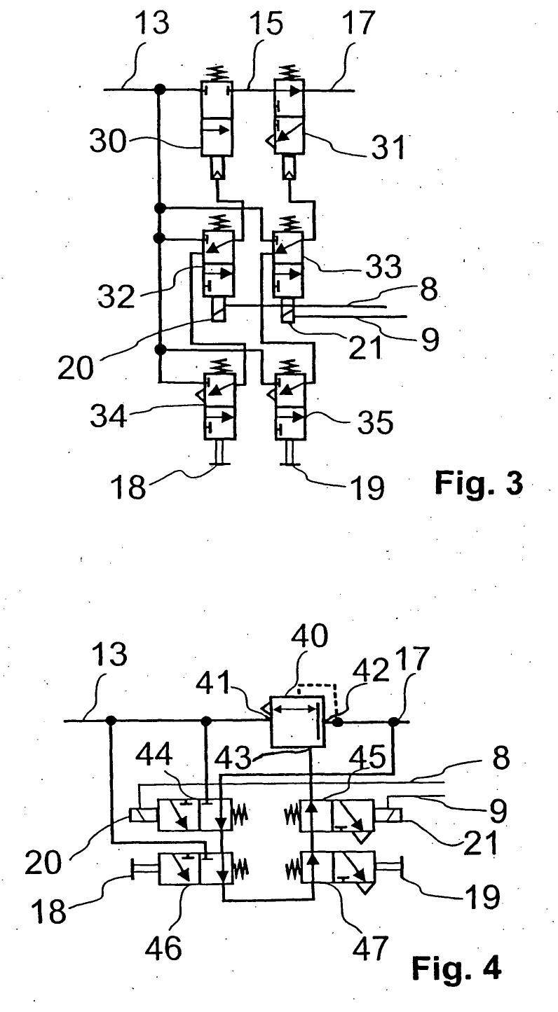

FIGS. 3 and 4 show practical examples of parts of an electronically controlled level-regulating device as a component of the air-suspension device, and

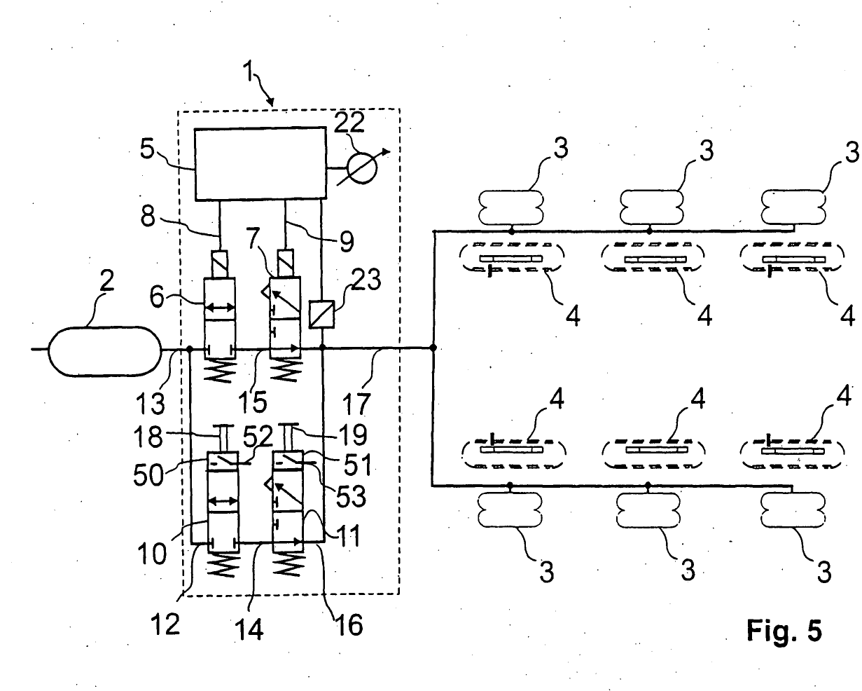

FIG. 5 shows a further practical example of an air-suspension device for a vehicle, all of the foregoing figures being schematic representations,

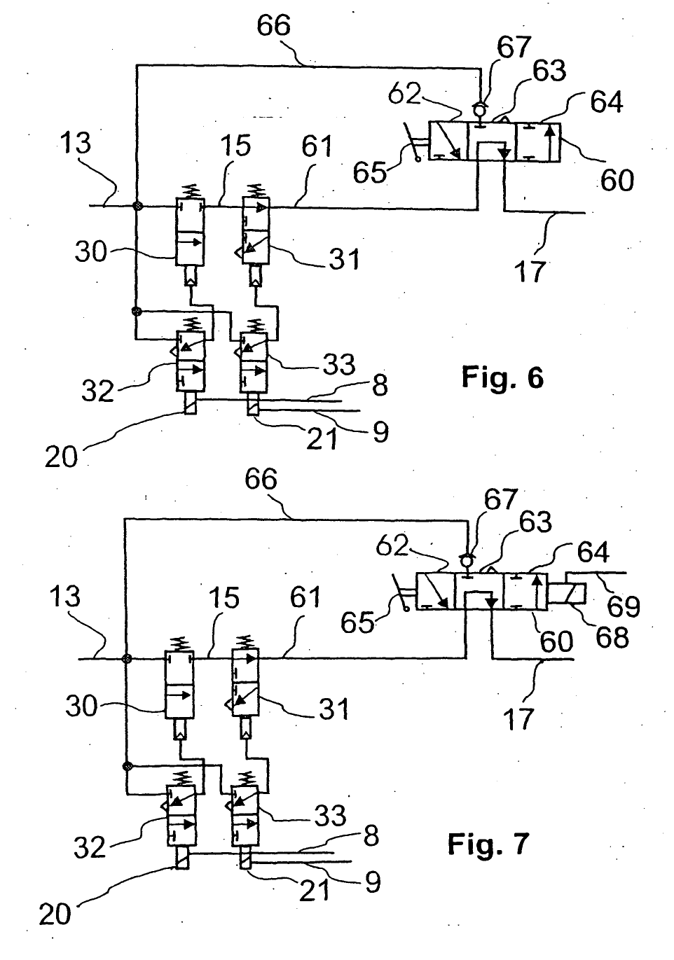

FIGS. 6 and 7 show further practical examples of parts of the air-suspension device.

In the figures, like reference numerals are used for parts corresponding to one another.

The air-suspension device for a vehicle illustrated in FIG. 1 is provided with air-suspension bellows (3), which are present in the vehicle in order to brace the vehicle body relative to wheels (4) or to the axles of the vehicle. The air-suspension device is also provided with an electronically controlled level-regulating device (1), which for admission of air to air-suspension bellows (3) controls a compressed-air supply flow from a pressurized-fluid source (2) in communication with the level-regulating device to air-suspension bellows (3), and for venting of air-suspension bellows (3) controls a compressed-air discharge flow from air-suspension bellows (3) into the atmosphere.

For the purpose of an electronic control, electronically controlled level-regulating device (1) is provided with an electronic control unit (5), which can be supplied by an electrical energy source (not illustrated in FIG. 1). From a displacement sensor (22), which is used to measure the distance of the vehicle body from a reference point relative to wheels (4) and which in this way determines the relative level of the vehicle body, electronic control unit (5) receives a relative-level signal via an electrical line. Furthermore, electronic control unit (5) receives a pressure signal from a pressure sensor (23), via an electrical line. Pressure sensor (23) is in communication on the pressure side with air-suspension bellows (3). Thus the transmitted pressure signal indicates the air pressure present in air-suspension bellows (3).

Using predefined algorithms, electronic control unit (5) ascertains whether the measured relative level of the vehicle body would necessitate admission of air to or venting of air-suspension bellows (3) in order to maintain a desired index relative level. Thereupon, by actuating an electrically actuatable valve device (6, 7), it brings about admission of air to or venting of air-suspension bellows (3) as needed, in order to adapt the relative level measured by means of displacement sensor (22) to the index relative level. Electrically actuatable valve device (6, 7) is provided with two electromagnetically actuatable valves (6, 7), which can be actuated by electronic control unit (5), by energizing electromagnets (20, 21) respectively via electrical lines (8, 9) respectively.

Valve (7), which is designed as a 3/2 directional control valve, is used as a combined inlet/outlet valve, which assumes an inlet position in the de-energized state of electromagnet (21), as illustrated in FIG. 1, and an outlet position in the energized state of electromagnet (21). Valve (6), which is designed as a 2/2 directional control valve, is used as a shutoff valve, which assumes a shutoff position in the de-energized state of electromagnet (20), as illustrated in FIG. 1, and a passing position in the energized state of electromagnet (20). For admission of air to air-suspension bellows (3), electronic control unit (5) switches shutoff valve (6) to passing position. Inlet/outlet valve (7) remains in inlet position. Hereby pressurized-fluid source (2) is placed in communication with air-suspension bellows (3), so that compressed air can flow from pressurized-fluid source (2) via compressed-air lines (13, 15, 17) and valves (6, 7) into air-suspension bellows (3). For venting of air-suspension bellows (3), electronic control unit (5) switches inlet/outlet valve (7) to outlet position. Hereby pressurized-fluid source (2) is shut off and air-suspension bellows (3) are placed in communication with a vent port of inlet/outlet valve (7), so that compressed air can flow from air-suspension bellows (3) via compressed-air lines (15, 17) and inlet/outlet valve (7) into the atmosphere. To hold the air pressure present in air-suspension bellows (3), electronic control unit (5) switches shutoff valve (6) to shutoff position. In the air-suspension device illustrated in FIG. 1, all air-suspension bellows (3) are controlled together and always have the same pressure. It is also common practice to combine the air-suspension bellows into wheel groups or axle groups or even to control each air-suspension bellows individually. In such a case the electronically controlled level-regulating device must be augmented by appropriate valves for individual control of the air-suspension bellows or the groups of air-suspension bellows.

In addition to the already explained parts of the air-suspension device, there are provided, as manual actuating elements, two momentary-contact switches (18, 19), by manual actuation of which admission of air to and/or venting of air-suspension bellows (3) is possible even in the absence of power supply to electronically controlled level-regulating device (1) or to electronic control unit (5).

According to an advantageous configuration of the invention, a valve device (10, 11), which can be manually actuated via manual actuating elements (18, 19), is provided in a compressed-air branch (12, 14, 16) that is parallel to electrically actuatable valve device (6, 7) and bypasses electrically actuatable valve device (6, 7). Manually actuatable valve device (10, 11) is advantageously designed as a pneumatic 2/2 directional control valve and a pneumatic 3/2 directional control valve. Such directional control valves can be manufactured simply and inexpensively and are highly reliable in use.

According to an advantageous configuration of the invention, momentary-contact switches (18, 19) are connected mechanically to pneumatic directional control valves (10, 11). Via momentary-contact switches (18, 19), directional control valves (10, 11) respectively can be actuated against the force of a restoring spring. Directional control valve (10) then acts as a shutoff valve, which assumes a shutoff position in the non-actuated state of momentary-contact switch (18), as illustrated in FIG. 1, and a passing position in the actuated state of momentary-contact switch (18). Directional control valve (11) acts as a combined inlet/outlet valve, which assumes an inlet position in the non-actuated state of momentary-contact switch (19), as illustrated in FIG. 1, and an outlet position in the actuated state of momentary-contact switch (19).

In the absence of power supply, a manual change of the relative level can be achieved by admitting air to or venting air-suspension bellows (3) as follows:

For air admission, momentary-contact switch (18) is manually actuated, meaning that directional control valve (10) is set to passing position. Hereby compressed air can flow from pressurized-fluid source (2) via compressed-air lines (12, 14, 16) through directional control valve (10) as well as directional control valve (11), which is in inlet position in the non-actuated state of momentary-contact switch (19), to air-suspension bellows (3). If it is desired to hold the air pressure or the relative level, momentary-contact switch (18) is merely released, whereby the flow of pressurized fluid is shut off. For venting, momentary-contact switch (19) is manually actuated, meaning that directional control valve (11) is set to outlet position. Hereby compressed air can flow out of air-suspension bellows (3) via compressed-air line (16) and via a vent port of directional control valve (11) into the atmosphere. If it is desired to hold the air pressure or the relative level beginning from this state, momentary-contact switch (19) is merely released.

According to an advantageous configuration of the invention, directional control valves (10, 11), together with the other parts of level-regulating device (1), are designed as a common module, for example by structurally integrating directional valves (10, 11) and the other parts of level-regulating device (1).

FIG. 2 illustrates a further advantageous configuration of the inventive air-suspension device, in which electrically actuatable valve device (6, 7) is coupled mechanically with the manual actuating elements, which here again are designed as momentary-contact switches (18, 19), and is capable of being manually actuated via the manual actuating elements. Hereby there is achieved a further improvement in terms of compactness and manufacturing costs of level-regulating device (1). According to the configuration of FIG. 2, valves (6, 7) of the electrically actuatable valve devices can be actuated optionally by their momentary-contact switches (18, 19) respectively or by their electromagnets (20, 21) respectively, in each case against spring force.

In FIG. 3 there is illustrated a further configuration of the air-suspension device illustrated in FIG. 1, only the part of electronically controlled level-regulating device (1) concerning the valve devices being shown as a detail in FIG. 3. The other parts of the air-suspension device correspond to FIG. 1.

According to FIG. 3 there are provided, as the electrically actuatable valve device, two 3/2 directional control valves (32, 33), which by analogy with the illustration of FIG. 1 can be actuated by electronic control unit (5) via electromagnets (20, 21) and electrical lines (8, 9). As the manually actuatable valve device there are provided two 3/2 directional control valves (34, 35), which can be manually actuated via the already mentioned momentary-contact switches (18, 19).

According to an advantageous configuration of the invention, a servo-valve device (30, 31) is additionally provided in FIG. 3 for admission of air to and/or venting of air-suspension bellows (3). This servo-valve device (30, 31) can be actuated at least by the electrically actuatable valve device (32, 33) and by manual actuation—indirectly via compressed-air actuation by directional control valves (34, 35) in this case—of manual actuating elements (18, 19).

Servo-valve device (30, 31) is composed of a 2/2 directional control valve (30) that can be actuated by pressurized fluid and of a 3/2 directional control valve (31) that can also be actuated by pressurized fluid. Valve (30) acts as the shutoff valve and valve (31) acts as the combined inlet/outlet valve, the functions of valves (30, 31) corresponding respectively to the functions already explained with respect to valves (6, 7) of FIG. 1. In contrast to valves (6, 7), valves (30, 31) can be actuated by the pressurized fluid, via respective pressurized-fluid control inputs. Shutoff valve (30) is in communication via its pressurized-fluid control input with a first pressurized-fluid port of valve (32). Valve (32) is also provided with two further pressurized-fluid ports, one of which is in communication with pressurized-fluid source (2) and the other with a first pressurized-fluid port of valve (34). Valve (34) is also provided with two further pressurized-fluid ports, one of which is in communication with pressurized-fluid source (2) and the other with the atmosphere, for venting purposes. The pressurized-fluid control input of inlet/outlet valve (31) is in communication with a first pressurized-fluid port of valve (33). Valve (33) is also provided with two further pressurized-fluid ports, one of which is in communication with pressurized-fluid source (2) and the other with a first pressurized-fluid port of valve (35). Valve (35) is also provided with two further pressurized-fluid ports, one of which is in communication with pressurized-fluid source (2) and the other with the atmosphere, for venting purposes.

Control of the relative level by appropriate action on electrically actuatable valve device (32, 33) takes place as already described with respect to FIG. 1. In the process, valves (32, 33) of the electrically actuatable valve device act as pilot-control valves for valves (30, 31) respectively. For electrical actuation of one of valves (30, 31), compressed air is admitted to the respectively connected pressurized-fluid control input of valves (30, 31). Without electrical actuation, venting of the respectively connected pressurized-fluid control input of valves (30, 31) takes place via venting of valves (34, 35) respectively. For manual actuation, again as already described with respect to FIG. 1, momentary-contact switch (18) is to be manually actuated for admission of air to air-suspension bellows (3), while momentary-contact switch (19) is to be manually actuated for venting. In the process, valves (34, 35) also act as pilot-control valves for valves (30, 31) respectively, whereupon the compressed air flows through valves (32, 33), which are then switched to passing position. During admission of air to air-suspension bellows (3), compressed-air flows from compressed-air source (2) via compressed-air lines (13, 15, 17) to air-suspension bellows (3). During venting, compressed-air flows from air-suspension bellows (3) via compressed-air line (17) and a vent port of inlet/outlet valve (31) into the atmosphere.

In FIG. 4 there is illustrated a further advantageous configuration of the inventive air-suspension device, only the part of electronically controlled level-regulating device (1) concerning the valve devices being shown, as in the case of FIG. 3. The other parts of the air-suspension device correspond to FIG. 1.

In the configuration according to FIG. 4 there is provided, as the servo-valve device, a relay-valve device (40), which has the characteristic that it outputs the pressure present at a pressure-control input (43) to a compressed-air output (42), while maintaining the same pressure head. For the purpose of venting compressed air from air-suspension bellows (3) into the atmosphere, relay-valve device (40) is provided with a vent port. To supply compressed air to air-suspension bellows (3), relay-valve device (40) is in communication, by means of a pressurized-fluid input port (41) and via compressed-air line (13), with compressed-air source (2).

As shown in FIG. 4, the electrically actuatable valve device is provided with a combined air-admission/holding valve (44), which is designed as a 3/2 directional control valve, and also with a vent valve (45), which is designed as a 2/2 directional control valve, which valves can be actuated by electronic control unit (5), via electromagnets (20, 21) respectively. By analogy with the aforesaid electrically actuatable valve device, the manually actuatable valve device is also provided with a combined air-admission/holding valve (46), which is designed as a 3/2 directional control valve, as well as with a vent valve (47), which is designed as a 2/2 directional control valve, which valves can be manually actuated by momentary-contact switches (18, 19) respectively. By means of respective pressurized-fluid input ports, electrically actuatable air-admission/holding valve (44) and manually actuatable air-admission/holding valve (46) are in communication via compressed-air line (13) with compressed-air source (2). Via vent valve (45), vent valve (47), air-admission/holding valve (46) and air-admission/holding valve (44), pressure-control input (43) of relay-valve device (40) is looped back to compressed-air output (42) of relay-valve device (40). If all valves of electrically actuatable valve device (44, 45) and manually actuatable valve device (46, 47) are not actuated, as illustrated in FIG. 4, pressure-control input (43) and compressed-air output (42) of relay-valve device (40) are in communication with one another. As a result, relay device (40) exerts a pressure-holding function, to the effect that the pressure present in compressed-air line (17) is held constant.

To exercise the level-regulating functions, and if air is to be admitted to air-suspension bellows (3), electronic control unit (5) acts via electrical line (8) on electromagnet (20) to actuate valve (44). Hereby compressed air is delivered from pressurized-fluid source (2) to pressure-control input (43). Relay-valve device (40) attempts to adjust the pressure at compressed-air output (42) to that present at pressure-control input (43), by the fact that relay-valve device (40) passes compressed air from pressurized-fluid input port (41) through to compressed-air output (42). If air-suspension bellows (3) are to be vented, electronic control unit (5) actuates electromagnet (21) via electrical line (9) in order to actuate valve (45). Hereby pressure-control input (43) of relay-valve device (40) is placed in communication with the vent port of vent valve (45) and therefore with the atmosphere. Relay-valve device (40) attempts to adjust the pressure at compressed-air output (42) to that present at pressure-control input (43), by the fact that relay-valve device (40) allows compressed air to flow out of air-suspension bellows (3) via the vent port of relay-valve device (40) into the atmosphere.

For a manual change of relative level, momentary-contact switch (18) is to be manually actuated for admission of air to air-suspension bellows (3) and momentary-contact switch (19) is to be manually actuated for venting of air-suspension bellows (3). In the process, the actuation of momentary-contact switch (18) brings about a reversal of air-admission/holding valve (46) to the effect that pressure-control input (43) of relay-valve device (40) is placed in communication with pressurized-fluid source (2). In turn, relay-valve device (40) attempts to adjust the pressure at compressed-air output (42) to that present at pressure-control input (43), by the fact that relay-valve device (40) passes compressed air from pressurized-fluid input port (41) through to compressed-air output (42). Actuation of momentary-contact switch (19) brings about a reversal of vent valve (47) to the effect that pressure-control input (43) of relay-valve device (40) is placed in communication with the vent port of vent valve (47). In turn, relay-valve device (40) attempts to adjust the pressure at compressed-air output (42) to that present at pressure-control input (43), by the fact that relay-valve device (40) allows compressed air to flow out of air-suspension bellows (3) via the vent port of relay-valve device (40) into the atmosphere.

According to an advantageous configuration of the invention, servo-valve device (30, 31, 40) is mechanically coupled with manual actuating element (18, 19) and can be manually actuated via manual actuating element (18, 19). In the case of the configuration of the servo-valve device according to FIG. 3, the manual actuating elements can be mechanically coupled with valves (30, 31) respectively, meaning that momentary-contact switch (18) is mechanically coupled with valve (30) and momentary-contact switch (19) with valve (31). In the case of the configuration of the servo-valve device according to FIG. 4, the manual actuating elements can be directly coupled mechanically with relay-valve device (40). This means, for example, that they can act mechanically from opposite sides on a relay piston provided in relay-valve device (40).

According to an advantageous improvement of the invention, electronically controlled level-regulating device (1) is suitable for receiving at least one input variable, to be predefined manually, which input variable can be predefined via manual actuating element (18, 19) even in the presence of power supply to electronically controlled level-regulating device (1). Such an input variable is preferably a manually predefined relative level or change of relative level compared with the previously adjusted relative level. This has the advantage that these same actuating elements can be used at any time to predefine the input variable, regardless of whether or not the level-regulating device is being supplied with electrical power. Additional actuating elements such as electric momentary-contact switches are not necessary. Furthermore, a simple kind of operator control is achieved hereby, since an operator does not have to make sure of actuating different operating elements according to the state of the power supply.

According to an advantageous improvement of the invention, electronically controlled level-regulating device (1) is suitable for receiving at least one distance signal from a displacement sensor (22) as well as one pressure signal from a pressure sensor (23). Level-regulating device (1) or electronic control unit (5) evaluates the distance signal and the pressure signal continuously, and on the basis of the variation of these signals detects whether an input variable such as a change of relative level has been predefined manually. In the process, electronic control unit (5) advantageously checks whether the distance signal is changing while the pressure signal remains substantially constant. This is an indication of a manually predefined change of relative level, to the effect that a certain quantity of air has been discharged from or injected into air-suspension bellows (3) at substantially constant vehicle weight. Since it can be assumed during such a manual change of relative level that the vehicle cargo and therefore the vehicle weight remained constant, the pressure in air-suspension bellows (3) does not change as a result, but instead only the volume of compressed air stored therein is changed by a change in relative level. However, if the electronic control unit detects that the pressure signal and the distance signal are changing, this is an indication that the vehicle cargo has been changed. In this case electronic control unit (5) does not infer a manually predefined input variable.

In FIG. 5 there is illustrated a further advantageous embodiment of the invention, which can also be used advantageously in combination with the already explained configurations of the invention. According to the configuration of FIG. 5, the manual actuating element, which in this case is momentary-contact switch (18), is mechanically coupled with an electric signal transmitter (50). Upon manual actuation of actuating element (18), an electric signal can be transmitted by electric signal transmitter (50). Electric signal transmitter (50), which can be designed as a switching contact, for example, is connected via an electrical line (52) to electronic control unit (5). Furthermore, the further manual actuating element of valve (11), or in other words momentary-contact switch (19), is mechanically coupled with a further electric signal transmitter (51). Upon manual actuation of actuating element (19), this further electric signal transmitter (51) also transmits an electric signal via a line (53) to electronic control unit (5).

This configuration of the invention has the advantage that, by means of electric signals, manual actuation of momentary-contact switches (18, 19) can be detected simply and with little additional complexity by electronic control unit (5). Hereby detection of manual actuation of momentary-contact switches (18, 19) is possible even if no pressure sensor is provided in the air-suspension device, or if such a sensor is defective. Thus there is no need for further operating elements such as a separate keyboard for manual input for the purpose of changing the relative level.

According to an advantageous improvement of the invention, electric signal transmitter (50, 51) respectively transmits an electric signal upon relatively light manual actuation of actuating element (18, 19) respectively. Upon relatively heavy manual actuation of actuating element (18, 19), the respective manually actuatable part of valve device (6, 7, 10, 11, 34, 35, 46, 47) is actuated. This has the advantage that, in the case of a pressure change brought about via compressed-air lines (13, 15, 17) in air-suspension bellows (3) in response to relatively heavy manual actuation of momentary-contact switches (18, 19), compressed-air branch (12, 14, 16), which is parallel to compressed-air lines (13, 15, 17), can be additionally connected into the circuit. Hereby a larger cross section, in the form of the sum of the flow cross sections of both compressed-air branches, is made available for the compressed air during a manual change of relative level, and so the manual change of relative level can be accomplished more rapidly.

According to an advantageous configuration of the invention, a rotary arm known from conventional rotary slide valves can also be used instead of two separate momentary-contact switches (18, 19). This rotary arm brings about admission of air to air-suspension bellows (3) in one end position and venting of air-suspension bellows (3) in another end position.

In FIGS. 6 and 7 there are illustrated further configurations of the air-suspension device illustrated in FIG. 1, only the part of electronically controlled level-regulating device (1) concerning the valve devices being shown as a detail in FIGS. 6 and 7. The other parts of the air-suspension device correspond to FIG. 1.

The configuration according to FIG. 6 is provided with servo valve device (30, 31), which has already been explained with reference to FIG. 3, and which can be actuated pneumatically via electrically actuatable 3/2 directional control valves (32, 33). By analogy with the embodiment according to FIG. 3, 3/2 directional control valves (32, 33) can be actuated by electronic control unit (5) via electrical lines (8, 9), by means of electromagnets (20, 21). In contrast to the illustration according to FIG. 3, however, the vent ports of valves (32, 33) are directly in communication with the atmosphere and not with further valves.

For manual actuation in order to admit air to and/or vent air-suspension bellows. (3), there is provided a three-position valve (60), which is designed as a rotary slide valve, and which is inserted in the pneumatic connection between compressed-air line (13), which is in communication with pressurized-fluid source (2), and compressed-air line (17), which is in communication with air-suspension bellows (3). For example, it is disposed between valve (31) and compressed-air line (17). Via a compressed-air line (61), this rotary slide valve (60) is in communication with valve (31). In order to supply reservoir pressure, rotary slide valve (60) is also in communication with compressed-air line (13), via a compressed-air line (66) as well as a check valve (67). Furthermore, rotary slide valve (60) is provided with a port for venting to the atmosphere.

Via a manual actuating element (65) designed as a rotary arm, rotary slide valve (60) can be actuated in the “Raise” (62), “Neutral” (63) and “Lower” (64) positions. In “Raise” position (62), compressed-air line (13) is in communication with compressed-air line (17), whereby air-suspension bellows (3) are filled with compressed air. In “Neutral” position (63), as illustrated in FIG. 6, valve (31) is in communication on the output side with compressed-air line (17), so that the level-regulating function can be exerted. In “Lower” position (64), compressed-air line (17) is in communication with the atmosphere, via a vent port of rotary slide valve (60), whereby air-suspension bellows are vented.

The further embodiment illustrated in FIG. 7-is provided with a rotary slide valve (60) having an integrated, electromagnetically tripped reset function. For this purpose rotary slide valve (60) is equipped with an electromagnet (68), which can be actuated by electronic control unit (5) via an electrical line (69). Actuation of electromagnet (68) brings about a mechanical reset of the rotary slide valve to “Neutral” position (63), regardless of the position in which rotary slide valve (60) was actuated beforehand. As an example of this capability, control unit (5) can automatically return rotary slide valve (60) to “Neutral” position, when the vehicle begins to move.

The person skilled in the art will recognize that different valve designs having “Raise”, “Neutral” and “Lower” positions can also be used instead of the rotary slide valve (60) illustrated as an example.

1. An air-suspension device for a vehicle, containing air-suspension bellows (3) and an electronically controlled level-regulating device (1), which, via an electrically actuatable valve device (6, 7, 32, 33, 44, 45), brings about admission of air to or venting of the air-suspension bellows (3) as needed, characterized in that there is provided at least one manual actuating element (18, 19, 65), by manual actuation of which admission of air to and/or venting of the air-suspension bellows (3) is possible even in the absence of power supply to the electronically controlled level-regulating device (1).

2. An air-suspension device according to claim 1, characterized in that a valve device (10, 11), which can be manually actuated via the manual actuating element (18, 19), is provided in a compressed-air branch (12, 14, 16) that is parallel to the electrically actuatable valve device (6, 7, 32, 33, 44, 45) and bypasses the electrically actuatable valve device (6, 7, 32, 33, 44, 45).

3. An air-suspension device according to claim 1, characterized in that the electrically actuatable valve device (6, 7, 32, 33, 44, 45) is coupled mechanically with the manual actuating element (18, 19), and is capable of being manually actuated via the manual actuating element (18, 19).

4. An air-suspension device according to claim 1, characterized in that a servo-valve device (30, 31, 40) is provided for admission of air to and/or venting of the air-suspension bellows (3), which servo-valve device (30, 31, 40) can be actuated at least by the electrically actuatable valves (6, 7, 32, 33, 44, 45) and by manual actuation of the manual actuating element (18, 19).

5. An air-suspension device according to claim 4, characterized in that the servo-valve device (30, 31, 40) is mechanically coupled with the manual actuating element (18, 19) and can be manually actuated via the manual actuating element (18, 19).

6. An air-suspension device according to at least one of the preceding claims, characterized in that the manual actuating element (65) is provided for actuation of a three-position valve (60), especially a rotary slide valve.

7. An air-suspension device according to at least one of the preceding claims, characterized in that the electronically controlled level-regulating device (1) is suitable for receiving at least one input variable, to be predefined manually, which input variable can be predefined via the manual actuating element (18, 19, 65) even in the presence of power supply to the electronically controlled level-regulating device (1).

8. An air-suspension device according to claim 7, characterized in that the electronically controlled level-regulating device (1) is suitable for receiving at least one distance signal from a displacement sensor (22) and at least one pressure signal from a pressure sensor (23), in which case the electronically controlled level-regulating device (1) detects on the basis of the distance signal and of the pressure signal whether an input variable has been manually predefined.

9. An air-suspension device according to at least one of the preceding claims, characterized in that the manual actuating element (18, 19) is designed as a momentary-contact switch.

10. An air-suspension device according to at least one of the preceding claims, characterized in that a further manual actuating element is provided, one (18) of the manual actuating elements being provided for actuation of air admission to the air-suspension bellows (3) and the other (19) manual actuating element being provided for actuation of venting of the air-suspension bellows (3).

11. An air-suspension device according to at least one of claims 1 to 8, characterized in that the manual actuating element (65) is designed as a rotary arm.

12. An air-suspension device according to at least one of the preceding claims, characterized in that the manual actuating element (18, 19, 65) is coupled mechanically with a directional control valve (6, 7, 10, 11, 34, 35, 46, 47, 60).

13. An air-suspension device according to at least one of the preceding claims, characterized in that the manual actuating element (18, 19, 65) is coupled mechanically with at least one electric signal transmitter (50, 51), and an electric signal can be transmitted by the signal transmitted (50, 51) upon manual actuation of the actuating element (18, 19, 65).

14. An air-suspension device according to claim 13, characterized in that the electric signal transmitter (50, 51) transmits an electric signal upon relatively light manual actuation of the actuating element (18, 19, 65) and the manually actuatable part of the valve device (6, 7, 10, 11, 34, 35, 46, 47, 60) is actuated upon relatively heavy manual actuation of the actuating element (18, 19, 65).

15. An air-suspension device according to at-least one of the preceding claims, characterized in that the manual actuating element (18, 19) is disposed in the same housing as the electrically actuatable valve device (6, 7, 32, 33, 44, 45).
